(19) United States
(12) Patent Application Publication
(10) Pub. No.: US 2005/0129023 A1
(43) Pub. Date: Jun. 16, 2005

(54) Method and device for compressing data packets

(75) Inventors: Sankar Narayan Jagannathan, Bangalor (IN); Jinan Lin, Ottobrunn (DE); Xiaoning Nie, Neubiberg (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Infineon Technologies AG

(21) Appl. No.: 10/987,639

(22) Filed: Nov. 12, 2004

(30) Foreign Application Priority Data
Nov. 14, 2003 (DE) 103 53 289.7

(51) Int. Cl. H04L 12/56

(52) U.S. Cl. 370/392

(57) ABSTRACT

A method for compressing a data packet is proposed, the data packet comprising at least a first data block and a second data block, the first data block referring to the second data block. In the method, the second data block is compressed and it is noted in the data packet that the second data block has been compressed. In one embodiment, the method is suitable for IPv6 data packets, the second data block then being, for example, a routing header.

### CROSS-REFERENCE TO RELATED APPLICATIONS

This Utility Patent Application claims priority to German Patent Application No. DE 103 53 289.7, filed on Nov. 14, 2003, which is incorporated herein by reference.

### BACKGROUND

The present invention relates to a method and to a device for compressing data packets, in particular data packets according to the IPv6 standard, and to a method and a device for decompressing data packets encoded using the method.

Data packets have long been sent via the Internet according to what is known as the IPv4 (Internet Protocol Version 4) standard. Each data packet has what is known as a header which contains, for example, a source address and a destination address as well as other information necessary to forward the data packet via the Internet or another network. For these data packets according to the IPv4 standard a compression algorithm is widely used for the header data, the algorithm being based on the fact that, in a sequence of data packets, the data in the header frequently does not change or changes only slightly, for example because all data packets are to be sent to the same address. Therefore, only data which changes frequently or coincidentally is transmitted in each header with this compression algorithm. Occasionally therefore a packet with a complete header is transmitted while subsequent headers are based on the header of the completely transmitted packet and only contain changes relating to this header.

These compression algorithms are based on a connection between two adjacent network nodes, a data packet typically being sent to the respective destination address via a large number of network nodes. It is necessary here for each packet to be decompressed and compressed again in each node. In addition, if many streams of data packets are to be sent via one connection, the situation may occur where the allocation of the header to a previously sent header is difficult and the data packets therefore have to be sent uncompressed with complete headers.

To take account of the steep growth in the Internet, a new standard, IPv6, has been proposed which, for example, can address a larger address space. With this standard what are known as “extension headers”, which, for example can contain a so-called routing table which indicates via which routers or network nodes the data packet is to be sent, can be used. These router tables often require a large amount of storage space.

### SUMMARY

One embodiment of the present invention provides a method and a device for compressing data packets and, in particular, header data, which does not require allocation of a data packet to a preceding data packet. One embodiment is suitable for the compression of headers according to the IPv6 standard.

According to one embodiment of the invention for compressing a data packet, the data packet comprising at least a first data block and a second data block and the first data block referring to a second data block, it is proposed to compress the second data block and it is to be noted in the data packet that the second data block has been compressed.

This noting can, for example, take place in the second data block, in particular in a field which indicates the second data block type. Furthermore, compression parameters like a Huffman table for decompressing said second data block may be stored in the data packet.

In one embodiment, the compression does not depend on the preceding data packets, but takes place within a single data packet.

The first data block can, in particular, be a main header of the data packet and the second data block an extension header of the data packet. The extension header can, for example, comprise network addresses via which the data packet is to be routed in a network.

In one embodiment, the method is suitable for compressing data packets according to the IPv6 standard, wherein the extension header can in this case be a routing header. In one embodiment, compression of the second data block is carried out here using a lossless compression algorithm, for example what is known as the Huffman algorithm. A Huffman table used for this purpose can be stored in the data packet and directly transmitted, but a predetermined Huffman table can also be used which, for example, takes account of generally occurring data symbol distributions.

In order to compress the Huffman table itself, for a first and a second data symbol, of which the codes correspond except for the last bit, it is possible for only the code of the first data symbol to be entered and the second data symbol to be associated with the first data symbol in the Huffman table. This means that in the representation of the Huffman table as a binary tree, in each case only the code which corresponds to a left-hand leaf or the code which corresponds to a right-hand leaf of the binary tree is ever transmitted. This principle can generally be applied in compression algorithms according to the Huffman method to reduce the Huffman table.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a structure of an IPv6 header.

FIG. 2 illustrates the structure of a data packet.

FIG. 3 illustrates the structure of a routing header according to the IPv6 standard.

FIG. 4 illustrates the structure of a data packet with the routing header from FIG. 3.

FIG. 5 illustrates the course of an embodiment of the method according to one embodiment of the invention and the mode of operation of an embodiment of a device according to one embodiment of the invention for compressing data packets.

FIG. 6 illustrates the mode of operation of a corresponding method and the corresponding device for decompressing data.

FIG. 7 illustrates a binary tree for determining codes for a compression according to the Huffman algorithm.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The embodiment described hereinafter is based on the compression of headers according to the IPv6 standard. The method according to the invention or the device according to the invention can, however, easily be transferred to other data packets and other components of data packets.

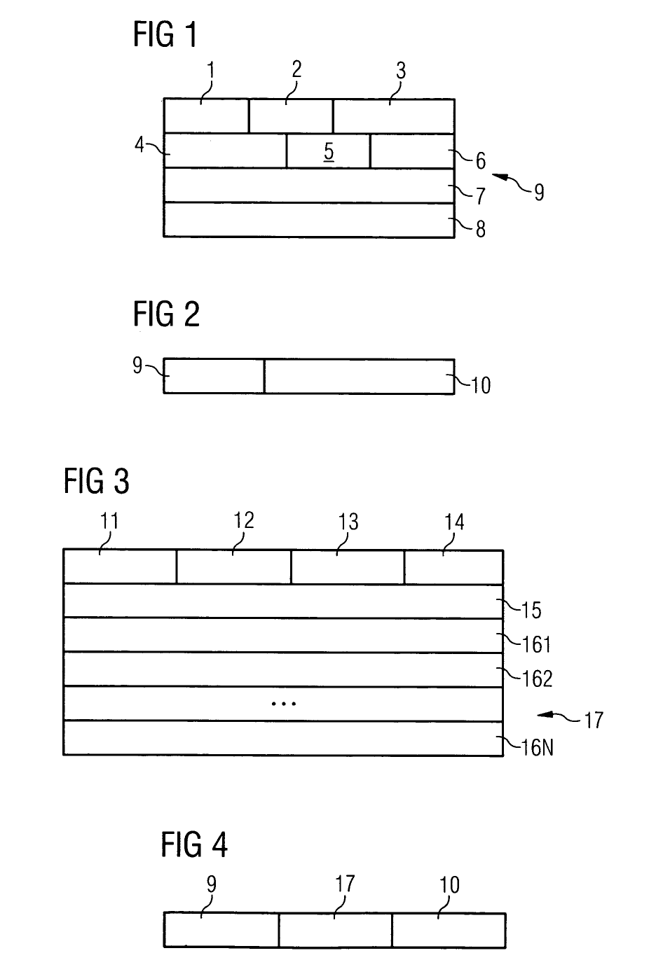

FIG. 1 illustrates the structure of an IPv6 header, the main header of the data packet as it were. The IPv6 header 9 has eight fields here. Field 1 has a length of 4 bits and indicates a version of the header. A 6, for example, stands for the IPv6 header here. Field 2 indicates a “Traffic class” which, for example, can designate a priority of the packet. Field 3 is 20 bits long, is designated a “flow label” and is used to receive control information for a packet flow. Field 4 is 16 bits long and indicates the length of the useful data following the IPv6 header. Field 5 has 8 bits and indicates what type of header follows next. If this field contains the decimal value 6, then the next header is a TCP header, in other words, the useful data follows directly. Other headers, which are known as extension headers, can be indicated here to predetermine further options for the transmission of data packets. Of these, the so-called routing header or routing extension header will be described in more detail hereinafter. Field 6 is also 8 bits long. Here a maximum number of hops (“hop limit”) can be predetermined for data transmission, a hop corresponding to transmission of the data packet from one network node to a further network node. If this number of hops is exceeded the data packet is deleted.

Field 7 is 128 bits and contains a source address of the data packet. Field 8 is also 128 bits long and contains a destination address of the data packet.

FIG. 2 illustrates the structure of a simple IPv6 data packet which contains the IPv6 header 9 and TCP header and data 10. In this case the field 5 of the IPv6 header 9 has the value 6.

As data packets in the Internet are not sent via fixed transmission paths, but rather the route of data packets may vary, it may be desirable to predetermine network nodes or so-called routers via which the data packet is to be routed. For this purpose, the possibility of providing the data packet with a so-called routing header as the extension header is provided in the IPv6 standard. FIG. 3 illustrates schematically the structure of a routing header 17 of this type. Field 11 of the routing header 17 corresponds here to field 5 of the header 9 from FIG. 1 and indicates the type of following header. Field 12 is also 8 bits long and indicates the length of the routing header. This can vary depending on the number of predetermined network nodes. Field 13 indicates the type of routing header and is 8 bits long. Up until now this was always the value 0 as there is currently only one type of routing header. Field 14 indicates how many of the predetermined network nodes still have to be processed; it is also 8 bits long. The maximum value of this field is currently 23. Field 15 is 32 bits long and is reserved for diverse, and also future, applications. It may contain a so-called “strict/loose bit map”, wherein each bit indicates for one of the following network node addresses whether the data packet has to be sent from the preceding network node directly to this network node or whether other network nodes can be located in between.

Following field 15 are N, where N is a maximum of 23, address fields 161 to 16N, which are each 128 bits in length and contain the addresses of the network nodes to be used.

When this routing header is processed in a node, a check is made as to whether field 14 is not equal to zero. If this is the case, the following address, and possibly the corresponding bit from the “strict/loose bit map”, pertaining to the address, is extracted. Field 8 of the IPv6 header 9 of the data packet and the corresponding address field 16 of the routing header 17 are then exchanged, so the data packet is forwarded to the next network node to be used.

FIG. 4 illustrates schematically the structure of a data packet which contains an IPv6 header 9 and a routing header 17. In addition, there is again a TCP header with associated data 10. In this case the field 5 of the IPv6 header 9 has the value 43 to indicate that a routing header follows. Field 11 of the routing header 17 accordingly has the value 6 in order to indicate that a TCP header follows. As each of the addresses 161 to 16N of the routing header 17 is 128 bits long, the routing header 17 can be very long. Therefore, the packet size can be reduced considerably by compressing this header.

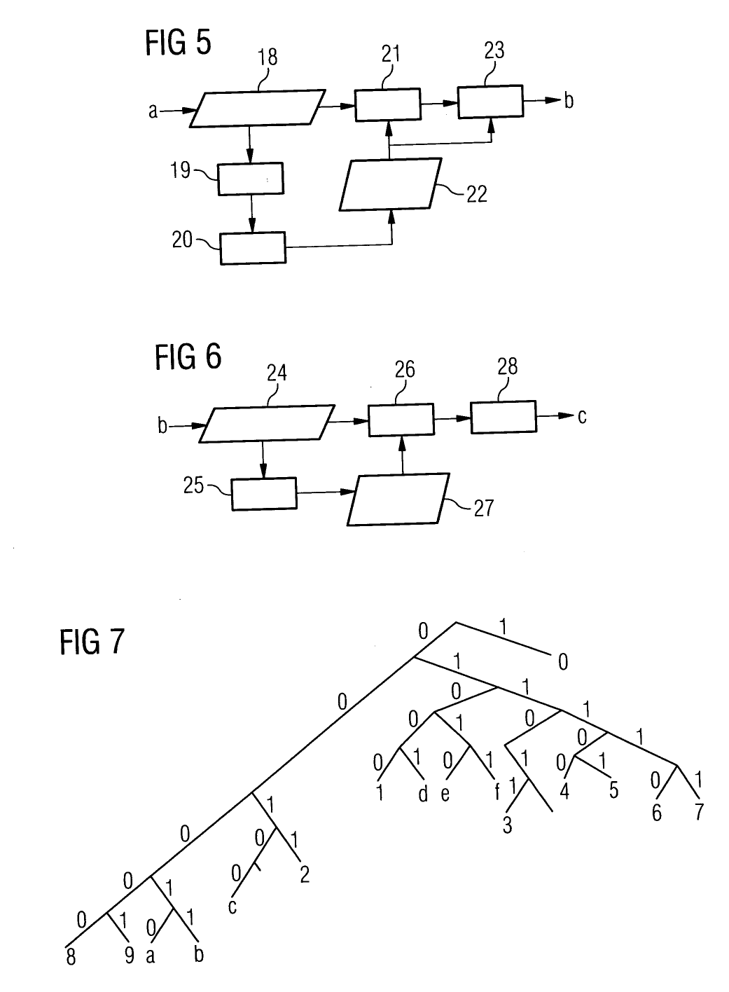

FIG. 5 illustrates an embodiment of the method according to one embodiment of the invention, whereby compression of this type can achieved. A data packet a to be sent, which, for example, has the format illustrated in FIG. 4, is stored in a buffer 18. The data block of the packet to be compressed, for example the routing header 17, or optionally only the addresses of the routing header 17, are extracted in a block 19. Optimum compression parameters for the extracted data block are ascertained in block 20. These compression parameters can, in particular, be codes for the individual data symbols of the extracted data block, as will be described below for a compression according to the so-called Huffman algorithm.

The ascertained compression parameters are stored in tabular form in a memory 22 and used in block 21 to compress the data block, in other words the routing header 17 in the present example. The table from the memory 22 is then added to the compressed data block in block 23. Of course, the compression parameters may be stored also in a form different from a table. In addition, the data block is identified as being compressed, and this can take place, for example, in that a field corresponding to field 11 is placed in front of the compressed data block and one of the numbers (101 to 255) previously not defined for this field is used in order to indicate that it is a compressed data block. However, it would, for example, also be possible to indicate this in field 5 of the IPv6 header 9 by means of a previously unused number. In addition, other fields can be used for the purpose of indicating the size of the table with the compression parameters, the size of the compressed data or the compression method. It may also be indicated whether just one header or data block or a plurality of data blocks or headers, optionally multiplexed, have been compressed.

In the case of a compressed routing header as in the present example, the fields 12, 13 and 14 are unchanged. In this example, a network node receiving the packet, which is not the final destination node, can, by means of the information there, decompress the address in a targeted manner using a suitable compression method, the address being required by the network node to forward the data packet, and can leave the remaining contents of the compressed routing header unchanged.

A device according to FIG. 5 can be produced as a hardware device, as software or as a combination of the two and be integrated in a router.

FIG. 6 illustrates a corresponding method for decompressing the compressed data packet b. The received data packet 6 is stored in a buffer 24. If it is found, in the present example with the aid of field 11 of the compressed routing header, that it is a compressed data packet, the compression parameters are extracted in block 25 and stored in a buffer 27. The compressed data block, for example the routing header 17, is decompressed by means of these compression parameters. It may possibly also be sufficient if only one address, indicating the next network node to be used, is decompressed. The header is then reproduced in block 28, that is, the additional data, such as for example the compression parameters, is deleted. The decompressed data packet c, corresponding to the original data packet a, can thus be further processed.

The so-called Huffman algorithm is used in this case as the compression algorithm. This is based on the fact that frequently occurring data symbols are allocated a short code, less frequently occurring data symbols, on the other hand, are allocated a longer code. This shall be described hereinafter with reference to an example. The following table shows an example of a typical routing header with 23 addresses. The fields correspond here to those illustrated in FIG. 3.

| | | | |
|---|---|---|---|
| 6 | 46 | 0 | 23 |

reserved
3ffe:2468:0:0:0:0:2dc0:b2b2
3ffe:3579:0:0:0:0:dec0:fac5
3ffe:1234:0:0:0:0:fe12:d0ca
2001:0210:0:0:0:0:3edd:b2fe
2001:0211:0:0:0:0:4cca:f2f2
2001:0324:0:0:0:0:6bde:c2ce
2001:0670:0:0:0:0:72fe:6dde
2001:5429:0:0:0:0:8deb:c63e
2001:6732:0:0:0:0:f230:aed0
2001:1134:0:0:0:0:3ffe:fec0
2001:1255:0:0:0:0:be2d:ce2b
2001:6004:0:0:0:0:bbda:02fc
2001:4432:0:0:0:0:7dde:baca
2001:1344:0:0:0:0:a2a2:aedb
2001:7832:0:0:0:0:f4fe:b2da
2001:ceda:0:0:0:0:c2de:acb3
2001:fed2:0:0:0:0:cafe:beda
2001:ec02:0:0:0:0:aade:deaf
2001:affe:0:0:0:0:e4f2:bea2
2001:8eff:0:0:0:0:d3af:600d
2001:56fd:0:0:0:0:4ead:5ffe
2001:2fed:0:0:0:0:b0dd:3afe
2001:eff1:0:0:0:0:2bfe:4ade

It can clearly be seen that the zero, for example, occurs very frequently in the addresses. The colons in the addresses are used here for the purpose of sub-division. The codes resulting according to the Huffman algorithm for the data symbols 0 to f used are shown in the following table, the Huffman code being given as a binary number.

| No. | Data symbol | Huffman code | Length |
|---|---|---|---|
| 1 | 0 | 1 | 1 |
| 2 | 1 | 01000 | 5 |
| 3 | 2 | 0011 | 4 |
| 4 | 3 | 011011 | 6 |
| 5 | 4 | 011100 | 6 |
| 6 | 5 | 011101 | 6 |
| 7 | 6 | 011110 | 6 |
| 8 | 7 | 011111 | 6 |
| 9 | 8 | 00000 | 5 |
| 10 | 9 | 00001 | 5 |
| 11 | a | 00010 | 5 |
| 12 | b | 00011 | 5 |
| 13 | c | 00100 | 5 |
| 14 | d | 01001 | 5 |
| 15 | e | 01010 | 5 |
| 16 | f | 01011 | 5 |

In this case the Huffman code “1”, which has a length of 1 bit, is allocated to the data symbol. On the other hand, the Huffman code 011110, which has length of 6 bits, is allocated to the substantially less frequently occurring data symbol 6.

The allocation can also be illustrated by means of a binary tree as illustrated in FIG. 7, the data symbols forming the “leaves” of the binary tree. The numbers 0 and 1 produce, on the path from the top of the tree to the respective data symbol, the code allocated to the data symbol in each case, read one after the other. If the routing header illustrated by way of example is compressed by means of the illustrated Huffman code, a total length of the compressed header results with respect to the table which indicates which Huffman code is allocated to which data symbol—a length of 2166 bits, of which 192 bits are allotted to the table. By contrast, the addresses of the uncompressed routing header alone have a length of 3072 bits, corresponding to a gain of 30.5%.

For longer address tables, which can also occur in data blocks, or if the method is applied to a large number of headers of this type, an even better compression ratio may even result, as is illustrated in the following table for five different examples. Here the address tables have between 84840 and 814464 entries. The gain in compression is above 50% in each case.

| IPv6 | | | | Gain in |
|---|---|---|---|---|
| Address | No. of | Original | Compressed | compression |
| table | entries | size (bytes) | size (bytes) | (%) |
| 1 | 814464 | 13031424 | 6081706 | 53.33 |
| 2 | 678720 | 10859520 | 5028230 | 53.69 |
| 3 | 329664 | 5274624 | 2414228 | 54.22 |
| 4 | 193920 | 3102720 | 1394411 | 55.05 |
| 5 | 84840 | 1357440 | 589504 | 56.57 |

An additional compression results when only the code for the symbol of the left-hand “leaf” of the binary tree from FIG. 7 is stored in the Huffman table in each case and the respective other data symbol of the adjacent right-hand leaf is allocated to the data symbol of the left-hand leaf. This results in a Huffman table as follows:

| No. | Data symbol 1 | Data symbol 2 | Huffman code |
|---|---|---|---|
| 1 | 8 | 9 | 00000 |
| 2 | a | b | 00010 |
| 3 | c | — | 00100 |
| 4 | 1 | d | 01000 |
| 5 | e | f | 01010 |
| 6 | 3 | — | 011011 |
| 7 | 4 | 5 | 011100 |
| 8 | 6 | 7 | 011110 |
| 9 | 0 | — | 1 |
| 10 | 2 | — | 0011 |

The Huffman code in each row is the Huffman code for the data symbol in the data symbol 1 column. The code for the data symbol in the data symbol 2 column is produced in that the last bit is inverted in each case.

A reduced Huffman table of this type can be used not only in the context of the described method for compressing data packets, but generally for compressing data using the Huffman algorithm and can be implemented both in terms of hardware, using fixed logic circuits, and also in terms of software. The length of the compressed header plus the Huffman table results in a length of 2114 bits for the illustrated example, the table now only having a length of 140 bits. The gain in compression has therefore increased to 31.3% per packet. If a plurality of routing headers are examined an even better ratio can generally be achieved here.

The present invention is not limited to the use of the Huffman algorithm. Any lossless compression algorithms such as arithmetic algorithms, algorithms of the LZ (Lempel-Ziv) family or adaptive algorithms can be used.

The compression can also be extended to other data blocks of the data packet. These other data blocks do not then have to be decompressed at all in network nodes which are not the network nodes predetermined by the destination address of the data packet.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method for compressing a data packet, comprising:
providing a data packet comprising at least a first data block and a second data block, the first data block containing a reference to the second data block;
compressing the second data block; and
noting in the data packet that the second data block has been compressed.

2. The method of claim 1, further including noting in an identifier of the second data block that the second data block has been compressed.

3. The method of claim 1, further including storing compression parameters used for compressing said second data block in said data packet.

4. The method of claim 1, wherein the first data block is a main header of the data packet, and wherein the second data block is an extension header of the data packet.

5. The method of claim 4, wherein the extension header comprises network addresses via which the data packet is to be routed in a network.

6. The method of claim 1, wherein the data packet is a data packet according to the IPv6 standard.

7. The method of claim 4, wherein the extension header is a routing header, data from fields of the extension header, which designate the extension header length, the routing header type and the number of network addresses still to be processed, not being compressed.

8. The method of claim 1, further including carrying out compression of the second data block using a lossless compression algorithm.

9. The method of claim 8, further including storing a coding table used for the compression in the data packet.

10. The method of claim 8, further including using the Huffman algorithm as the compression algorithm.

11. The method of claim 10, wherein, for a first and a second data symbol, each of which have codes that correspond except for the last bit, only the code of the first data symbol is entered in a Huffman table for the Huffman algorithm and the second data signal is associated with the first data symbol in the Huffman table.

12. The method of claim 10, further including using a predetermined Huffman table for the Huffman algorithm.

13. The method of claim 1, further including checking whether it has been noted in the data packet that the second data block has been compressed, and decompressing the second data block if it is found that the second data block has been compressed.

14. The method of claim 13, wherein the data packet comprises a routing header having a plurality of network addresses, wherein only a next network address to be processed in each case is decompressed from the routing header.

15. A method for compressing data, comprising:
compressing data using the Huffman algorithm;
providing a first and a second data symbol, each having codes that correspond except for the last bit;
entering only the code of the first data symbol; and
associating the second data symbol with the first data symbol in the Huffman table.

16. A device for compressing a data packet having at least a first data block and a second data block, the first data block containing a reference to the second data block, the device comprising:
data processing means for compressing the second data block and for noting in the data packet that the second data block is compressed.

17. The device of claim 16, wherein it is noted in an identifier of the second data block that the second data block has been compressed.

18. The device of claim 16, wherein said data processing means are adapted such that compression parameters used for compressing said second data block are stored in said data packet.

19. The device of claim 16, wherein the first data block is a main header of the data packet, and wherein the second data block is an extension header of the data packet.

20. The device of claim 19, wherein the extension header comprises network addresses via which the data packet is to be routed in a network.

21. The device of claim 16, wherein the data packet is a data packet according to the IPv6 standard.

22. The device of claim 19, wherein the extension header is a routing header, said data processing means adapted such that data from fields of the extension header, which designate the extension header length, the routing header type and the number of network addresses still to be processed, not being compressed.

23. The device of claim 16, wherein compression of the second data block is carried out using a lossless compression algorithm.

24. The device of claim 23, wherein a coding table used for the compression is stored in the data packet.

25. The device of claim 23, wherein the Huffman algorithm is used as the compression algorithm.

26. The device of claim 25, wherein, for a first and a second data symbol, of which the codes correspond except for the last bit, only the code of the first data symbol is entered in a Huffman table for the Huffman algorithm and the second data signal is associated with the first data symbol in the Huffman table.

27. The device of claim 25, wherein a predetermined Huffman table is used for the Huffman algorithm.

28. The device of claim 16, wherein said device further comprises decompression means for checking whether it has been noted in the data packet that the second data block has been compressed, and wherein the second data block is decompressed if it is found that the second data block has been compressed.
